(19) United States
(12) Patent Application Publication
(10) Pub. No.: US 2021/0019911 A1
(43) Pub. Date: Jan. 21, 2021

(54) INFORMATION PROCESSING DEVICE, INFORMATION PROCESSING METHOD, AND RECORDING MEDIUM

(71) Applicant: SONY CORPORATION, TOKYO (JP)

(72) Inventors: YURI KUSAKABE, TOKYO (JP); TAKUYA IKEDA, TOKYO (JP); KENTARO IDA, TOKYO (JP)

(21) Appl. No.: 16/766,929

(22) PCT Filed: Sep. 4, 2018
(86) PCT No.: PCT/JP2018/032721

§ 371 Date: May 26, 2020

(30) Foreign Application Priority Data
Dec. 4, 2017 (JP) 2017-232613

(51) Int. Cl. G06T 7/73; G06F 3/01; G02B 27/01

(52) U.S. Cl. CPC G06T 7/75; G06F 3/011; G02B 2027/0138; G02B 2027/014; G02B 27/0172

(57) ABSTRACT

[Problem] To provide an information processing device, an information processing method, and a recording medium that can present a notification related to a real object more intuitively.

[Solution] An information processing device includes a control unit configured to perform: processing of determining whether a real object associated with notification content is present in the same space as a person to be notified at the time when a notification condition associated with the notification content is satisfied; and processing of outputting the notification content to a position related to the real object depending on whether the real object is present.

### FIELD

The present disclosure relates to an information processing device, an information processing method, and a recording medium.

### BACKGROUND

In the related art, as a method of managing information such as task management and messaging, slips and whiteboards are used as an analog method, and smartphones that are widespread these days and terminal devices of smart glasses are used as a digital method.

In recent years, a technique of implementing various user interfaces and new user interaction has been developed.

For example, the following Patent Literature 1 discloses a technique of displaying a message near a user's feet at the moment when the user comes home and switches on a lighting fixture by linking a projector attached to a roof of a room with a switch of the lighting fixture.

### CITATION LIST

### Patent Literature

Patent Literature 1: JP 2014-21428 A

### SUMMARY

### Technical Problem

However, in Patent Literature 1 described above, a timing of presenting information is limited to the time when the switch of the lighting fixture is turned on, and an output place is also limited to a region under the lighting fixture.

A slip or a whiteboard is fixed to a certain place, so that the user cannot carry information and cannot check the information at a required timing. The user can carry the information if a terminal device is used, but cannot notice a notification of a task or a message at a timing when the user does not carry the terminal device.

There may be a case of using a real object to finish a task, but in the related art, presence or absence of the real object at a notification timing of the task has not been sufficiently considered.

Thus, the present disclosure provides an information processing device, an information processing method, and a recording medium that can make more intuitive presentation about a notification related to the real object.

### Solution to Problem

According to the present disclosure, an information processing device is provided that includes: a control unit configured to perform processing of determining whether a real object associated with notification content is present in a same space as a person to be notified at the time when a notification condition associated with the notification content is satisfied, and processing of outputting the notification content to a position related to the real object depending on whether the real object is present.

According to the present disclosure, an information processing method is provided that includes: determining, by a processor, whether a real object associated with notification content is present in a same space as a person to be notified at the time when a notification condition associated with the notification content is satisfied; and outputting, by the processor, the notification content to a position related to the real object depending on whether the real object is present.

According to the present disclosure, a recording medium in which a computer program is recorded is provided, the computer program for causing a computer to function as a control unit configured to perform: processing of determining whether a real object associated with notification content is present in a same space as a person to be notified at the time when a notification condition associated with the notification content is satisfied; and processing of outputting the notification content to a position related to the real object depending on whether the real object is present.

### Advantageous Effects of Invention

As described above, according to the present disclosure, it is possible to make more intuitive presentation about a notification related to a real object.

The effect described above is not necessarily limited, and any one of effects described in the present description or another effect that may be grasped from the present description may be exhibited in addition to the effect described above, or in place of the effect described above.

### BRIEF DESCRIPTION OF DRAWINGS

FIG. 1 is a diagram for explaining an outline of an information processing system according to one embodiment of the present disclosure.

FIG. 2 is a block diagram illustrating an example of a configuration of a system according to the present embodiment.

FIG. 3 is a diagram for explaining an input of a task related to a real object using a digital pen according to the present embodiment.

FIG. 4 is a flowchart illustrating an example of a procedure of registration processing of the system according to the present embodiment.

FIG. 5 is a diagram illustrating a screen example of a registration UI according to the present embodiment.

FIG. 6 is a flowchart illustrating an example of registration processing of a notification condition included in additional information of a task according to the present embodiment.

FIG. 7 is a flowchart illustrating an example of registration processing of attribute information included in the additional information of the task according to the present embodiment.

FIG. 8 is a diagram illustrating an example of determination of importance based on handwritten content according to the present embodiment.

FIG. 9 is a flowchart illustrating an example of a procedure of notification processing according to the present embodiment.

FIG. 10 is a diagram illustrating an example of output representation of task importance according to the present embodiment.

FIG. 11 is a diagram illustrating an example of task display in a case in which the real object is not present nearby according to the present embodiment.

FIG. 12 is a diagram illustrating an example of pool display according to the present embodiment.

FIG. 13 is a diagram illustrating another example of pool display according to the present embodiment.

FIG. 14 is an explanatory diagram illustrating a hardware configuration of an information processing device according to the present disclosure.

### DESCRIPTION OF EMBODIMENTS

The following describes a preferred embodiment of the present disclosure in detail with reference to the attached drawings. In the present description and the drawings, constituent elements having substantially the same functional configuration are denoted by the same reference numeral, and redundant description will not be repeated.

The description will be made in the following order.
1. Outline of information processing system according to one embodiment of present disclosure
2. Configuration example
   2-1. Input device 200
   2-2. Sensor device 300
   2-3. Output device 400
   2-4. Information processing device 100
3. Operation processing
   3-1. Registration processing
   3-2. Notification processing
4. Complement
   4-1. Pool display
   4-2. Application example
   4-3. Effect
5. Hardware configuration
6. Conclusion

### 1. OUTLINE OF INFORMATION PROCESSING SYSTEM ACCORDING TO ONE EMBODIMENT OF PRESENT DISCLOSURE

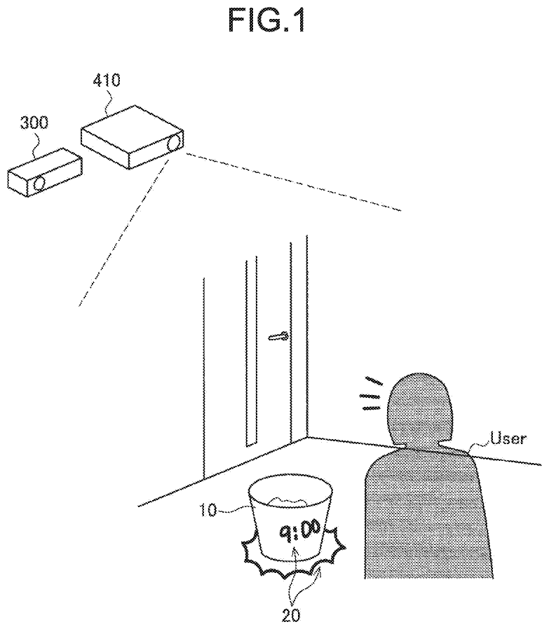

FIG. 1 is a diagram for explaining an outline of an information processing system according to one embodiment of the present disclosure. The information processing system according to the present embodiment includes an information processing device 100 (not illustrated in FIG. 1), a sensor device 300 (a camera is illustrated as an example in FIG. 1), and an output device 400 (a projector 410 is illustrated as an example in FIG. 1).

The sensor device 300 is a device that senses various kinds of information. For example, the sensor device 300 includes a camera, a depth sensor, and a microphone, and senses information related to a user and a space in which the user is present. For example, the sensor device 300 senses a position, a posture, a motion, and a line of sight of the user, a shape of a room, and an arrangement of real objects such as furniture, a household electrical appliance, a trash can, an interior article, and daily necessaries. The number of the sensor devices 300 may be one or plural.

The output device 400 is a device that outputs various kinds of information from the information processing device 100, and assumed to be the projector 410, for example. The projector 410 can project information on an optional place (that is, a region) such as a wall, a floor, a table, or a piece of furniture included in the space that is sensed by the sensor device 300 as a projection place (that is, a projection surface or a projection region). The projector 410 may be implemented by a plurality of projectors, or by what is called a moving projector so that projection can be performed on any place in the space. The number of the output devices 400 may be one or plural.

### BACKGROUND

As described above, various user interaction techniques have been developed in the related art. However, in the technique disclosed in Patent Literature 1 described above, a timing of presenting information is limited to the time when a switch of a lighting fixture is turned on, and an output place is also limited to a region under the lighting fixture.

A slip or a whiteboard is fixed to a certain place, and a user cannot carry information to check the information at a required timing. If a terminal device is used, the user can carry the information, but cannot notice a notification of a task or a message at a timing when the user does not carry the terminal device.

The task or the message is assumed to be related to a real object such that “Taking out garbage at 9:00 a.m.” or “Put a letter in a post”, but in the related art, an input or an output of notification information related to the real object has not been sufficiently considered.

Thus, the present disclosure provides a mechanism that can make more intuitive presentation about a notification related to the real object in the space.

For example, as illustrated in FIG. 1, in a case in which a real object 10 is present around the user at the time of notifying the user of notification information associated with the real object 10 at a predetermined notification timing, notification information 20 is projected on the real object 10 by the projector 410 to enable the notification related to the real object to be made more intuitively.

### 2. CONFIGURATION EXAMPLE

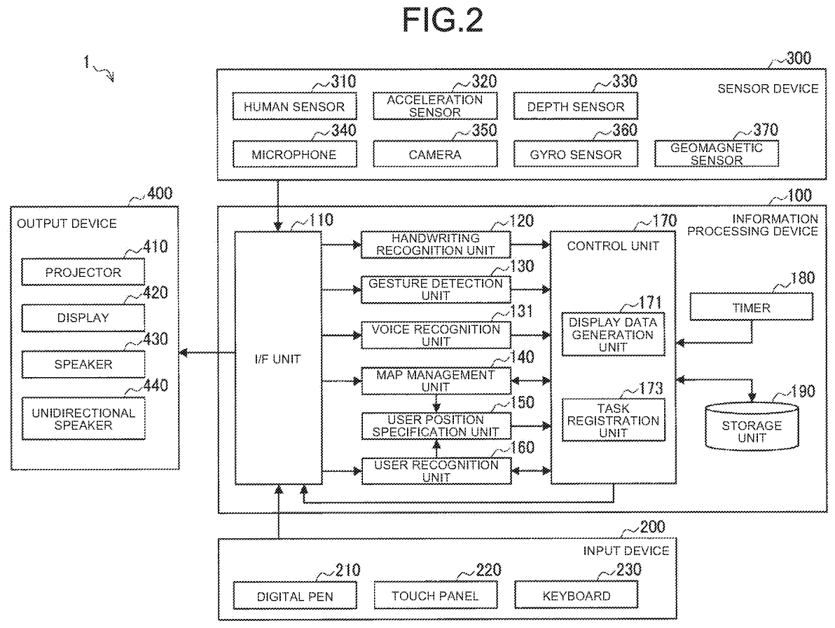

FIG. 2 is a block diagram illustrating an example of a configuration of a system 1 according to the present embodiment. As illustrated in FIG. 2, the system 1 includes the information processing device 100, an input device 200, the sensor device 300, and the output device 400.

2-1. Input Device 200

The input device 200 includes a digital pen 210, a touch panel 220, and a keyboard 230.

The digital pen 210 is an electronic operation body on which a light emitting unit such as an infrared (IR) light emitting diode (LED) is mounted. The light emitting unit emits light when a button, a switch, or the like disposed on the digital pen 210 is operated, when a pen point is pressed against a ground plane, or when the pen oscillates, for example. The digital pen 210 may transmit, to the information processing device 100, a predetermined command based on a user operation of the button or the switch disposed on the digital pen 210, movement of the pen, or the like.

The touch panel 220 and the keyboard 230 are disposed on a device such as a smartphone, a tablet terminal, a smart watch, smart eyeglasses, and a PC, and detects a user operation to be transmitted to the information processing device 100. The touch panel 220 and the keyboard 230 may be disposed on a wall, a floor, a table, a door, and the like in a house.

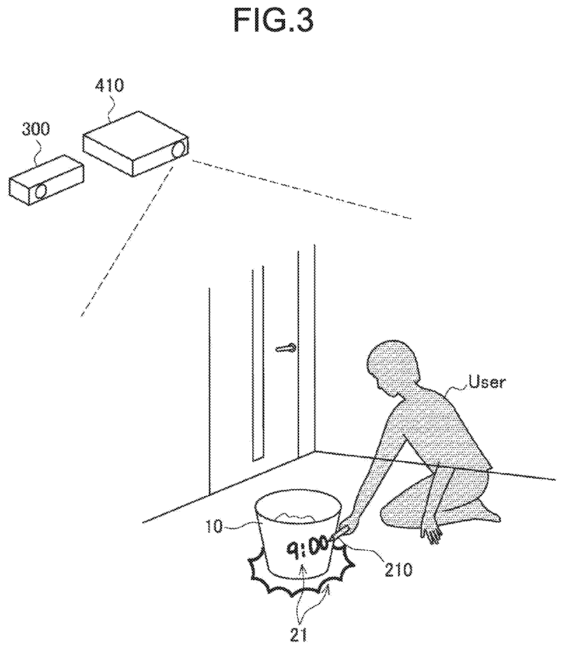

The user can input a task related to an optional real object in the space to the information processing device 100 using the input device 200. FIG. 3 illustrates a diagram for explaining the input of the task related to the real object using the digital pen 210. As illustrated in FIG. 3, the user performs writing on the real object 10 that is planned to be used for finishing the task using the digital pen 210. In this case, the information processing device 100 detects a luminous point of the light emitting unit disposed at the pen point to recognize handwriting with the sensor device 300 disposed in a real space, and performs visual feedback control for projecting a handwriting image 21 by the projector 410. The information processing device 100 recognizes the real object 10 with the sensor device 300, and registers the handwriting image 21 as a task. In this way, the user can freely perform writing on every real object in the real space, and can intuitively register the task related to the real object. In a case in which the real object related to the task is not present in the vicinity of the user, a name of the real object and the like may be written with the digital pen 210 to be registered as a task in the information processing device 100. In a case of a task that is required to be notified while being associated with the user himself/herself instead of the real object, the task can be registered in the information processing device 100 as a task associated with the user himself/herself by writing content of the task on a wall, a floor, and the like at a present place.

As an input unit, a fingertip, a voice, and a gesture may be used in addition to the digital pen 210, or a device such as a smartphone, a tablet terminal, a smart watch, smart eyeglasses, and a PC may be used. Alternatively, the input device 200 may acquire medium information such as an image or a moving image to be input to the information processing device 100.

The input device 200 may also include an optional constituent element with which information can be input by the user other than the constituent elements described above. For example, the input device 200 may include a mouse, a button, a switch, a lever, and the like.

2-2. Sensor Device 300

The sensor device 300 includes a human sensor 310, an acceleration sensor 320, a depth sensor 330, a microphone 340, a camera 350, a gyro sensor 360, and a geomagnetic sensor 370.

The human sensor 310 is a device that detects presence/absence of a person. The human sensor 310 is, for example, an optical sensor using infrared rays and the like. The acceleration sensor 320, the gyro sensor 360, and the geomagnetic sensor 370 are motion sensors that detect a motion of a person, and may be disposed on a terminal device such as a wearable device and a smartphone owned by the user. The depth sensor 330 is a device that acquires depth information such as an infrared range finding device, an ultrasonic range finding device, Laser Imaging Detection and Ranging (LiDAR), or a stereo camera. The microphone 340 is a device that collects surrounding sound, and outputs voice data obtained by converting the surrounding sound into a digital signal via an amplifier and an analog digital converter (ADC). The microphone 340 may be an array microphone. The camera 350 is an imaging device such as an RGB camera that includes a lens system, a driving system, and an imaging element, and takes an image (a static image or a moving image). The number of the cameras 350 may be plural, and the camera 350 may be a movable type that can photograph an optional direction in the space.

The sensor device 300 senses information based on control performed by the information processing device 100. For example, the information processing device 100 can control a zoom factor and an imaging direction of the camera 350.

The sensor device 300 may also include an optional constituent element that can perform sensing other than the constituent elements described above. For example, the sensor device 300 may include various sensors such as an illuminance sensor, a force sensor, an ultrasonic sensor, an atmospheric pressure sensor, a gas sensor (Co2), and a thermocamera.

2-3. Output Device 400

The output device 400 includes the projector 410, a display 420, a speaker 430, and a unidirectional speaker 440. The system 1 may include, as the output device 400, one of these components or a combination of a plurality of these components, or may include a plurality of devices of the same type.

The projector 410 is a projection device that projects an image on an optional place in the space. The projector 410 may be a wide-angle projector of a fixed type, for example, or may be what is called a moving projector including a movable part that can change a projecting direction such as a Pan/Tilt driving type. For example, the display 420 may be disposed on a TV, a tablet terminal, a smartphone, a PC, and the like. The TV is a device that receives radio waves of television broadcast, and outputs an image and a voice. The tablet terminal is typically a mobile apparatus that has a larger screen than that of a smartphone and can perform wireless communication, and can output an image, a voice, vibration, and the like. The smartphone is typically a mobile apparatus that has a smaller screen than that of the tablet and can perform wireless communication, and can output an image, a voice, vibration, and the like. The PC may be a desktop PC of a fixed type, or may be a notebook PC of a mobile type, and can output an image, a voice, and the like. The speaker 430 converts voice data into an analog signal to be output (reproduced) via a Digital Analog Converter (DAC) and an amplifier. The unidirectional speaker 440 is a speaker that can form directivity in a single direction.

The output device 400 outputs information based on control performed by the information processing device 100. The information processing device 100 can also control an output method in addition to the content of the information to be output. For example, the information processing device 100 can control the projecting direction of the projector 410, or control directivity of the unidirectional speaker 440.

The output device 400 may also include an optional constituent element that can make an output other than the constituent elements described above. For example, the output device 400 may include a wearable device such as a head mounted display (HMD), augmented reality (AR) glasses, and a clock-type device. The output device 400 may also include a lighting device, an air conditioning device, a music reproducing device, a household electrical appliance, and the like.

2-4. Information Processing Device 100

The information processing device 100 includes an interface (IF) unit 110, a handwriting recognition unit 120, a gesture detection unit 130, a voice recognition unit 131, a map management unit 140, a user position specification unit 150, a user recognition unit 160, a control unit 170, a timer 180, and a storage unit 190.

I/F Unit 110

The I/F unit 110 is a connection device for connecting the information processing device 100 to another appliance. For example, the I/F unit 110 is implemented by a Universal Serial Bus (USB) connector and the like, and inputs/outputs information to/from each of the constituent elements, that is, the input device 200, the sensor device 300, and the output device 400. For example, the I/F unit 110 is connected to the input device 200, the sensor device 300, and the output device 400 via a wireless/wired local area network (LAN), Digital Living Network Alliance (DLNA) (registered trademark), Wi-Fi (registered trademark), Bluetooth (registered trademark), or other private lines. The I/F unit 110 may be connected to another appliance via the Internet or a home network.

Handwriting Recognition Unit 120

The handwriting recognition unit 120 has a function of recognizing handwriting of the user that is written by an operation body such as the digital pen 210 or a finger in the real space based on the information sensed by the sensor device 300. Specifically, the handwriting recognition unit 120 analyzes a taken image (a taken image obtained by imaging a handwriting image projected by the projector 410) acquired from the camera 350, performs character recognition, and performs morphological analysis, semantic analysis, and the like on an extracted character string. In the character recognition, an action at the time of writing (an order of making strokes in writing, a writing start position, a writing end position, and the like) may be referred to in addition to the handwriting image. The handwriting recognition unit 120 can also identify a writer by pattern recognition and the like using machine learning. The handwriting recognition unit 120 outputs a recognition result to the control unit 170.

Gesture Detection Unit 130

The gesture detection unit 130 has a function of detecting a gesture of the user based on the information sensed by the sensor device 300. Specifically, the gesture detection unit 130 detects the gesture such as a posture of the user and a motion of a head, a hand, or an arm using the acceleration sensor 320, the depth sensor 330, the camera 350, the gyro sensor 360, and the geomagnetic sensor 370 included in the sensor device 300. The gesture detection unit 130 outputs a detection result to the control unit 170.

Voice Recognition Unit 131

The voice recognition unit 131 has a function of recognizing a voice of the user based on the information sensed by the sensor device 300. Specifically, the voice recognition unit 131 extracts an uttered voice of the user from voice information collected by the microphone 340 included in the sensor device 300, performs voice recognition (converts the voice into text), and performs morphological analysis, semantic analysis, and the like on an acquired character string. The voice recognition unit 131 outputs a recognition result to the control unit 170.

Map Management Unit 140

The map management unit 140 has a function of generating a map within the space and performing what is called space recognition such as recognition of the real object based on the information sensed by the sensor device 300. Specifically, the map management unit 140 acquires information indicating shapes of objects forming the space such as a wall surface, a roof, a floor, a door, furniture, daily commodities, and the like (information indicating the shape of the space) based on the depth information obtained by infrared range finding, ultrasonic range finding, or a stereo camera, for example. The information indicating the shape of the space may be two-dimensional information, or may be three-dimensional information such as a point cloud.

The map management unit 140 also acquires three-dimensional position information of the real object present in the space based on the infrared range finding, the ultrasonic range finding, the taken image, and the depth information.

The sensor device 300 is disposed in every place in a living space, for example. The map management unit 140 can recognize every room in the living space such as an entrance, a corridor, a kitchen, a living room, a dining room, a study, a bedroom, a bathroom, a washroom, and a veranda, and can map the arrangement of the real objects in each room.

User Position Specification Unit 150

The user position specification unit 150 has a function of specifying a position of the user in a three-dimensional space recognized by the map management unit 140. Specifically, the user position specification unit 150 recognizes (estimates) a position in the three-dimensional space recognized by the map management unit 140 corresponding to the position of the user recognized by the user recognition unit 160. The user position specification unit 150 outputs information indicating the specified position of the user in the space to the control unit 170.

User Recognition Unit 160

The user recognition unit 160 has a function of recognizing the user in the space based on the information sensed by the sensor device 300, and acquiring information about the user. For example, based on information acquired by a thermocamera, an RGB camera, a stereo camera, an infrared sensor, an ultrasonic sensor, or the like included in the sensor device 300, the user recognition unit 160 performs personal identification and the like based on presence/absence, a position, sight line information including a position of a viewpoint and a sight line direction, a posture, face recognition, and the like of a person. The user recognition unit 160 outputs acquired user information to the control unit 170.

The various kinds of recognition and detection described above are performed regularly, continuously, or intermittently, and a recognition result and a detection result are stored in the storage unit 190 by the control unit 170.

Control Unit 170

The control unit 170 functions as an arithmetic processing unit and a control device, and controls the entire operations in the information processing device 100 in accordance with various computer programs. The control unit 170 may be implemented by an electronic circuit such as a central processing unit (CPU) and a microprocessor, for example. The control unit 170 may also include a read only memory (ROM) that stores a computer program to be used, an arithmetic parameter, and the like, and a random access memory (RAM) that temporarily stores a parameter and the like that vary as appropriate.

The control unit 170 also includes a display data generation unit 171 and a task registration unit 173.

The display data generation unit 171 generates display data to be output by the output device 400. Specifically, first, the display data generation unit 171 recognizes a locus of a line drawn by the digital pen 210, a fingertip, or the like (that is, movement position of the digital pen 210 or the fingertip) based on sensing data acquired from the sensor device 300. For example, the display data generation unit 171 analyzes a movement locus of the luminous point of the light emitting unit disposed at the pen point of the digital pen 210 or the fingertip of the user based on the taken image acquired by the camera 350, the depth information, and the like. The display data generation unit 171 then generates a handwriting image that displays the recognized locus (this is an image as feedback of a handwriting input of the user, so that the image displaying the locus is referred to as the “handwriting image” herein).

The display data generation unit 171 also generates a registration user interface (UI) at the time of task registration. The display data generation unit 171 further generates a notification image for notifying the task registered in the storage unit 190.

The task registration unit 173 performs processing of storing (registering) the task (an example of the notification information) in the storage unit 190 based on the information input from the sensor device 300 and the input device 200. For example, the task registration unit 173 stores the character string recognized by the handwriting recognition unit 120, or the handwriting image taken by the camera 350 or generated by the display data generation unit 171 (a character string, a chart, an illustration, and the like) (these are examples of notification content) in a notification list (this may be also referred to as a task list) of the storage unit 190 together with additional information. The additional information includes a notification condition (notification time, a user to be notified, a notification place, and a real object used for finishing the task) and attribute information (importance, security information, and a repetition setting). The control unit 170 extracts the additional information from a written character string, information input to the registration UI that is displayed at the time of task registration, a gesture or a voice of the user, and the like. The task registration unit 173 may also register a user voice as the task.

The control unit 170 also controls a display output and a voice output from the output device 400.

Specifically, the control unit 170 according to the present embodiment determines whether the notification condition for the task registered in the storage unit 190 is satisfied, and in a case in which the notification condition is satisfied, performs control to output corresponding notification content from the output device 400. For example, the control unit 170 determines whether the registered notification condition is satisfied based on timer information output from the timer 180, the position of the user in the space specified by the user position specification unit 150, a result of identifying the user obtained by the user recognition unit 160, and the like.

In a case in which real object information is registered in the task to be notified, the control unit 170 determines whether a predetermined real object is present in the same space (for example, in the same room) as the user as a person to be notified. In a case in which the real object is present, the control unit 170 performs control for displaying (for example, projecting) a character string, a handwriting image, or the like registered as a task at a position related to the real object, that is, on the real object or around the real object. In a case in which an output function (a display unit, a voice output unit, and the like) is provided to the real object itself, the control unit 170 may perform control for causing the real object to display a character string, a handwriting image, or the like registered as a task, or reproducing a voice registered as a task, a predetermined notification sound, or the like. In a case in which the real object is present at a blind spot of the user (the blind spot of the user is recognized based on orientation of a head part of the user (person to be notified) or the sight line information), the control unit 170 may sound the real object or a device in the vicinity of the real object, may cause a lighting fixture of the real object or a device in the vicinity of the real object to blink, or may project a display image for guiding the user to the real object in the sight line direction of the user by the projector 410. On the other hand, in a case in which the real object is not present, the control unit 170 performs control for displaying the character string, the handwriting image, or the like registered as a task in any of output regions (for example, a projection region such as a wall or a table positioned in the sight line direction of the user) in the same space as the user (person to be notified) together with information indicating the real object (a name, an image, or the like of the real object). The output regions in the same space as the user (person to be notified) include take-alongs such as a smartphone, a cellular telephone terminal, a smart watch, smart eyeglasses, and an HMD owned by the user.

At the time of notifying the task, the control unit 170 may process the registered character string, the handwriting image, or the like to be displayed in accordance with the registered attribute information.

Timer 180

The timer 180 measures time, and outputs timer information to the control unit 170.

Storage Unit 190

The storage unit 190 is implemented by a read only memory (ROM) that stores a computer program, an arithmetic parameter, and the like used for processing performed by the control unit 170, and a random access memory (RAM) that temporarily stores a parameter and the like that vary as appropriate.

The task (notification information) is stored in the storage unit 190 by the task registration unit 173.

The configurations of the system 1 according to the present embodiment have been specifically described above. The configuration of the system 1 illustrated in FIG. 2 is merely an example, and the present embodiment is not limited thereto. For example, although not illustrated in FIG. 2, another device may be connected to the information processing device 100.

The information processing device 100 may be constituted of a plurality of devices. The information processing device 100 may also be implemented by a smart home terminal, a PC, a home server, an edge server, an intermediate server, or a cloud server.

### 3. OPERATION PROCESSING

Subsequently, the following specifically describes a procedure of operation processing of the system 1 according to the present embodiment with reference to the drawings.

3-1. Registration Processing

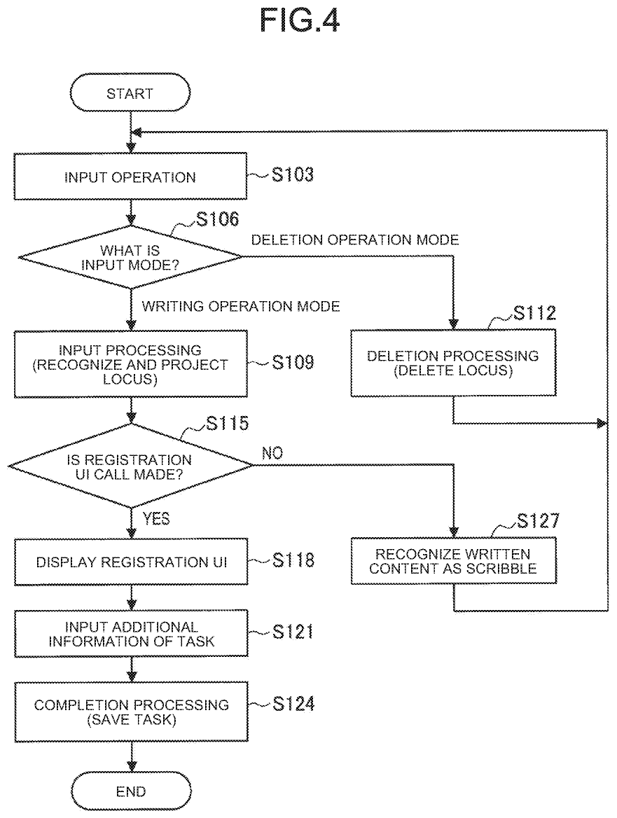

First, with reference to FIG. 4, the following describes an example of a procedure of registration processing of the system 1 according to the present embodiment. FIG. 4 is a flowchart illustrating an example of the procedure of registration processing of the system 1 according to the present embodiment.

As illustrated in FIG. 4, first, the information processing device 100 detects an input operation (first input operation) on an environmental object performed by the user using the digital pen 210 or a fingertip based on the information acquired from the input device 200 or the sensor device 300 (Step S103). The environmental object is an object constituting an environment such as a wall, a floor, a window, a door, a bed, a desk, a table, a chair, a refrigerator, a trash can, and a plastic bottle, and includes the “real object” according to the present embodiment. As described above, the real object is every object that is present in the real space and assumed to be used for finishing the task such as furniture, a household electrical appliance, a trash can, an interior article, and daily necessaries, for example. The information processing device 100 according to the present embodiment can detect a handwriting input action on the environmental object as an input operation by the user by analyzing a stroke of a human hand using the digital pen 210 or a fingertip (a motion of a hand or an arm drawing a character or a chart), and the luminous point of the light emitting unit (IR LED and the like) disposed at the pen point of the digital pen 210 based on the sensing data acquired from the sensor device 300. The information processing device 100 may start to detect such a handwriting input action at the time when a switch of the digital pen 210 is turned on, or at the time when a predetermined command utterance, a predetermined gesture operation, or the like are detected.

Next, the information processing device 100 determines an input mode (deletion operation mode/writing operation mode) of the detected input operation (Step S106). The input mode may be determined based on a stroke of a user's hand or a locus of the luminous point of the pen point of the digital pen 210, or may be determined based on switching of the switch of the digital pen 210. For example, in a case in which the locus of the luminous point of the pen point of the digital pen 210 forms a cancel line or a predetermined cancel mark, the information processing device 100 determines that the input mode is the deletion operation mode. In a case in which the locus of the luminous point of the pen point of the digital pen 210 forms a shape other than the cancel line or the predetermined cancel mark (for example, some chart, a character, a symbol, and a simple line), the information processing device 100 determines that the input mode is the writing operation mode.

Subsequently, in a case of the writing operation mode, the information processing device 100 performs input processing (Step S109). Specifically, the information processing device 100 performs control for recognizing the locus of the line drawn by the digital pen 210 or a fingertip (the movement locus constituted of movement positions of the digital pen 210 or the fingertip), generating an image displaying the recognized locus, and projecting the generated image on the recognized movement locus from the projector 410. Due to this, the user is enabled to perform handwriting input on every environmental object in the real space without being regionally restricted like a display screen of a terminal device. According to the present embodiment, more intuitive and simpler input can be implemented in daily life by employing the handwriting input, and convenience of management of the task that may be generated in the living space is greatly improved. By directly registering a chart, an illustration, and a character input by handwriting as a task to be displayed at the time of task notification (described later), the user is enabled to intuitively grasp content, importance, and urgency of the task, and remember a feeling of himself/herself or a situation at the time of input by viewing the character written by himself/herself.

On the other hand, in a case of the deletion operation mode, the information processing device 100 performs deletion processing (Step S112). For example, in a case of detecting an input operation of a cancel line, the information processing device 100 performs control for causing a canceled character, chart, illustration, and the like not to be displayed.

Subsequently, in a case in which a registration UI call is made (Yes at Step S115), the information processing device 100 displays the registration UI for registering the additional information related to the task in the vicinity of the user (Step S118). In a case in which the user wants to register the task input by handwriting, the user performs an operation to be a trigger for advancing the process to the registration processing (second input operation, the registration UI call in this case). The registration UI call may be drawing of a specific mark using the digital pen 210, a predetermined gesture operation or voice, or a pressing and holding operation of the digital pen 210.

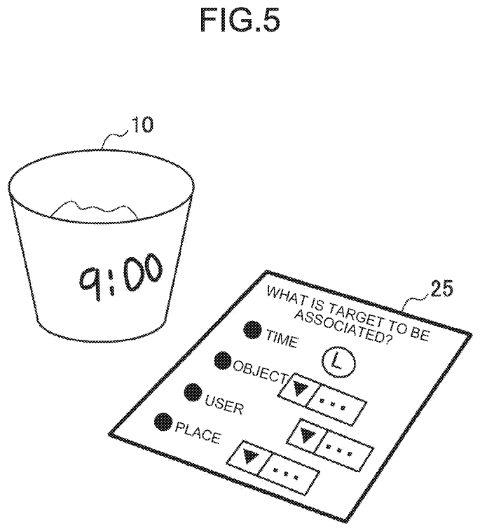

FIG. 5 illustrates a screen example of the registration UI. As illustrated in FIG. 5, a registration UI 25 is projected to be displayed in the vicinity of the real object 10 on which the user performs handwriting input by the digital pen 210, for example. On the registration UI 25, an input box (for example, a pull-down type or a handwriting input type) for the additional information is displayed, the additional information to be registered in association with the task. The user can designate notification time, an object (a real object used for finishing the task), a user (a person to be notified of the task. The user may be a registrant himself/herself (that is, the registrant of the task and the person to be notified are the same person), or may be another person such as a member of family. The person to be notified is not necessarily designated), and a place (a place where the task is finished, a notification place) via the registration UI 25. To a box of the “object” (the real object used for finishing the task), a name of the real object 10 recognized by the system side (for example, “trash can”) may be presented to be checked by the user. The user does not necessarily input all pieces of the additional information displayed on the registration UI 25. Items displayed on the registration UI 25 are not limited to the example illustrated in FIG. 5, and an optimum registration UI may be generated to be displayed in accordance with a situation. For example, registration UIs different for each user may be generated, additional information that is previously estimated based on machine learning for task registration may be presented as a candidate, and in accordance with a place such as a living room and a bedroom, a person who often uses the place or time when the place is often used may be estimated and presented as a candidate for the additional information.

Next, the information processing device 100 inputs the additional information of the task (Step S121). The information processing device 100 acquires the information input on the displayed registration UI 25 by the user with the digital pen 210, a finger, or the like based on the sensing data acquired from the sensor device 300. The present embodiment describes a case of displaying the registration UI by way of example, but the present embodiment is not limited thereto. The information processing device 100 may extract the additional information based on a voice, a gesture, or handwriting content of the user without displaying the registration UI. The additional information includes a notification condition (notification time, a user to be notified, a place, and a real object used for finishing the task), and the attribute information (importance, security information, and a repetition setting (snooze function)).

The information processing device 100 then performs completion processing (Step S124). Specifically, the information processing device 100 performs processing of storing a character, a chart, an illustration, and the like written on the environmental object in the storage unit 190 in association with the additional information (registration processing). The character, the chart, the illustration, and the like written on the environmental object may be saved as it is as an image, or text (a character string) that is recognized at the same time and a processing result such as a semantic analysis result may also be saved. In a case in which the task content (notification content) is written as “taking out garbage” with the digital pen 210, a time condition of the notification condition is assumed to be “9:00 a.m. XX/XX”, and the real object is assumed to be a trash can, for example, a saving format of the task is as follows. Object Data is point group data in a case of the real object, and is identification data such as a face recognition data in a case of the user.

### Example of Saved Data

Tag, Object Data, Drawing, Data, Time
{“trash can”}, {point cloud}, {“hoge.png”}, {YYYY.MM.DD.HH.MM.SS}

At the time of saving the task, the information processing device 100 may feed completion of registration back to the user using a sound or an image. After the registration, the information processing device 100 may cause the projected handwriting image and registration UI not to be displayed.

The completion processing may be performed in accordance with a registration completion operation performed by the user. For example, the user may tap a completion button on various displayed GUIs such as the projected registration UI with the digital pen 210, a touch pen, a fingertip, and the like. The registration completion operation may be writing a specific mark with the digital pen 210 and the like, enclosing a written task with a specific mark, or drawing an underline. The registration completion operation may also be a gesture such as whisking the written task by hand, or inputting a specific command such as “register” by voice.

On the other hand, in a case in which the registration UI call at Step S115 described above is not made (No at Step S115), the information processing device 100 recognizes the written content as scribble remaining at the present place (Step S127). In this case, the information processing device 100 may cause the written content recognized as scribble to be deleted (not to be displayed) after a certain time has elapsed. Due to this, the user can enjoy scribbling on any place such as a floor, a wall, and a desk.

The procedure of registration processing according to the present embodiment has been described above with reference to FIG. 4. The operation processing illustrated in FIG. 4 is merely an example, and the present disclosure is not limited to the example illustrated in FIG. 4. For example, the present disclosure is not limited to an order of steps illustrated in FIG. 4. At least some of the steps may be performed in parallel, or may be performed in reverse order. For example, pieces of the processing from Step S103 to Step S109 and pieces of the processing from Step S115 to Step S118 may be performed in parallel, or may be performed in reverse order. That is, the registration UI call is made beforehand to display the registration UI, and the task content may be input to the environmental object (including the real object) with the digital pen 210 and the like thereafter.

All pieces of the processing illustrated in FIG. 4 are not necessarily performed. For example, a registration call for simply registering a written task may be made without performing the processing of registration UI call from Step S115 to Step S118. The user can make the registration call after writing the additional information, and register the task and the additional information. After the deletion processing at Step S112, the process may proceed to the registration UI call at Step S115. This is because, after some of characters are deleted, the rest of the characters, an illustration, and the like may be registered as a task.

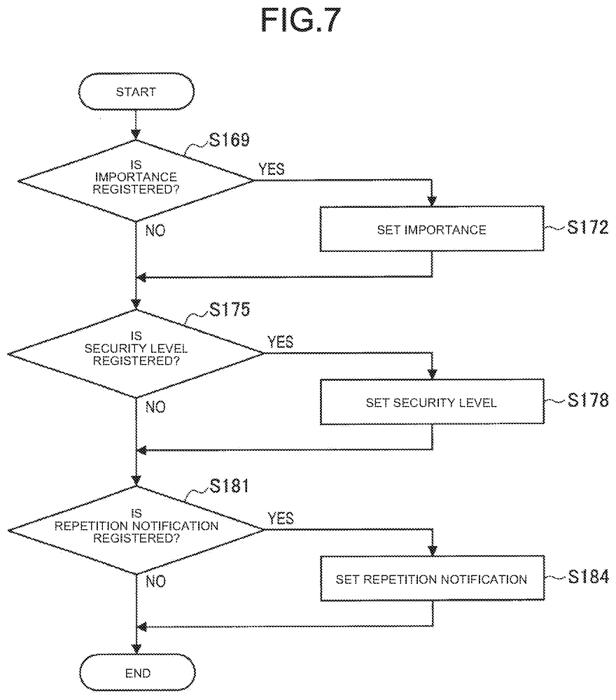

All pieces of the processing illustrated in FIG. 7 are not necessarily performed by a single device, and the pieces of processing are not necessarily performed in temporal sequence.

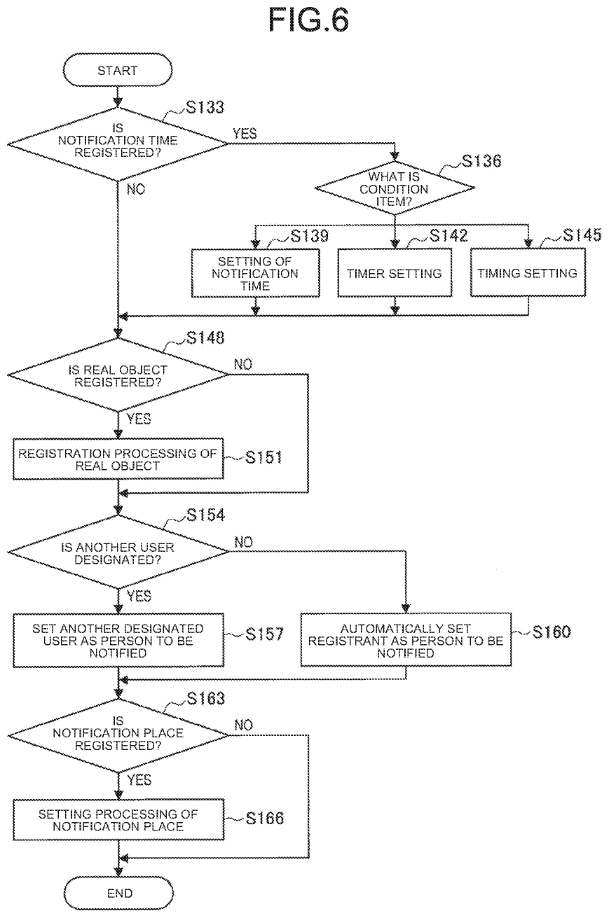

Subsequently, the following specifically describes registration of the additional information of the task according to the present embodiment from Step S121 to Step S124 described above with reference to FIG. 6 to FIG. 7.

FIG. 6 is a flowchart illustrating an example of registration processing of the notification condition included in the additional information of the task according to the present embodiment. As illustrated in FIG. 6, first, in a case of registering the notification time (Yes at Step S133), the information processing device 100 performs setting of the notification time (Step S139), timer setting (Step S142), or timing setting (Step S145) in accordance with a condition item (Step S136).

Information about the notification time may be acquired from a user input to the registration UI, or may be acquired from the written content. As the setting of the notification time, a year, a month, a date, an hour, and a minute can be set. In a case in which the timer setting is performed, the information processing device 100 starts to measure time with the timer 180. Regarding the timing setting, sunset or a predetermined timing depending on weather and the like, specifically, various situations such as “when it rains”, “when it is sunny”, “when it is hot”, “when evening comes”, and “in the morning” can be set as the notification timing. The information processing device 100 may acquire, from a cloud and the like, sunset time or time at which weather will be changed, and set the acquired time as the notification time.

Next, in a case of registering the real object used for (related to) finishing the task (Yes at Step S148), the information processing device 100 registers the real object information. The real object information may be acquired from the user input to the registration UI, or may be acquired from the written content. For example, the real object can be designated and registered by touching a target real object, writing a specific mark on the target real object, or enclosing the target real object with a specific mark by the user with the digital pen 210. A method of designating the real object may be touching the real object by a fingertip, or pointing at the real object by gesture. In this way, by using the real object at the time of task registration, the real object can be designated more intuitively and simply. The real object related to the finish of the task is not limited to an inorganic substance, and may be another user, a pet, and the like.

Even in a case in which the real object related to the task is not present in the vicinity of the user, there may be a case of thinking of a task and starting to input task content at a present place. In this case, the real object may be designated by writing a name of the real object. For example, at a place where a trash can is not present nearby, the information processing device 100 acquires and registers the task content of “9:00 a.m. tomorrow” and the real object information of “trash can” from writing of “9:00 a.m. tomorrow trash can”.

Subsequently, the person to be notified is set (Step S154 to Step S160). Specifically, for example, in a case in which the user (registrant) designates a person other than himself/herself (another user. The number thereof may be one or plural) via the registration UI and the like (Yes at Step S154), the information processing device 100 sets the designated other user as the person to be notified (Step S157). In a case in which the person to be notified is unspecified such as any member of user's family living together, the user may set the person to be notified as “unspecified” or “anybody”.

On the other hand, in a case in which another user is not designated (No at Step S154), the information processing device 100 automatically sets the registrant of the task (user himself/herself) as the person to be notified (Step S160).

In this way, as the person to be notified of the task, in addition to the registrant himself/herself of the task, another user living together with the user in the living space can be designated, or a user not living with the user but being designated by the user can be set.

Next, in a case of registering the notification place (Yes at Step S163), the information processing device 100 performs setting processing of the notification place (Step S166). As a place where the task is notified, an environmental object, a take-along, and a situation other than the real object can be set such as an entrance, a kitchen, a living room, someone's room, a smartphone, a TV, a smart watch, and the periphery of the person to be notified. By setting the notification place, in a case of inputting “9:00 a.m. tomorrow trash can”, for example, it is possible to specify a room in which “trash can” is present. Designation of the notification place may be performed by using a name of a place, or by displaying a map (for example, room arrangement of the living space) to acquire a position of a pin placed by the user.

The registration processing of the notification condition included in the additional information according to the present embodiment has been specifically described above. The notification condition according to the present embodiment is not limited to the items described above. An additional item may be added, and all of the items described above are not necessarily registered. For example, the person to be notified, the real object, or the notification place is not necessarily set. This is because there may be a case in which a target of the task is any person living together with the user in the living space, or the real object is not used for finishing the task.

The operation processing illustrated in FIG. 6 described above is merely an example, and the present disclosure is not limited to the example illustrated in FIG. 6. For example, the present disclosure is not limited to an order of steps illustrated in FIG. 6. At least some of the steps may be performed in parallel, or may be performed in reverse order. For example, pieces of the processing from Step S133 to Step S145, pieces of the processing from Step S148 to Step S151, pieces of the processing from Step S154 to Step S160, and pieces of the processing from Step S163 to Step S166 may be performed in parallel, or may be performed in reverse order.

All pieces of the processing illustrated in FIG. 6 are not necessarily performed, and all pieces of the processing are not necessarily performed by a single device. The pieces of processing illustrated in FIG. 6 are not necessarily performed in temporal sequence.

Subsequently, the following describes registration processing of the attribute information with reference to FIG. 7. FIG. 7 is a flowchart illustrating an example of the registration processing of the attribute information included in the additional information of the task according to the present embodiment.

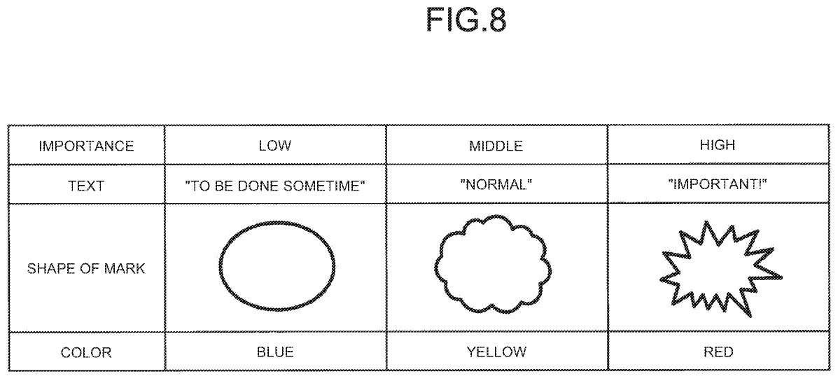

As illustrated in FIG. 7, first, in a case of registering the importance (Yes at Step S169), the information processing device 100 sets the importance based on the content of the user input to the registration UI and the written content (that is, the handwritten content) (Step S172). FIG. 8 illustrates an example of determination of the importance based on the handwritten content.

As illustrated in FIG. 8, for example, as a result of character recognition of the written content, the information processing device 100 sets “importance: low” in a case in which text of “to be done sometime” is extracted, sets “importance: middle” in a case in which text of “normal” is extracted, and sets “importance: high” in a case in which text of “important!” is extracted.

Also in a case in which a specific mark as illustrated in FIG. 8 is drawn, the information processing device 100 may set corresponding importance. The user can set the importance by enclosing the written task or the real object by the specific mark illustrated in FIG. 8. The specific mark illustrated in FIG. 8 may also be used for the registration UI call or the registration completion operation described above. When the user encloses the written task or the real object by the specific mark illustrated in FIG. 8 to set the importance, the registration UI for setting the notification condition and the like may be displayed, and registration may be completed at the same time if the notification condition and the like have been already written.

The information processing device 100 may also set the importance as illustrated in FIG. 8 in accordance with a color of a pen of the handwriting input (a color of the projected handwriting). For example, “importance: low” may be set in a case in which the handwriting is blue, “importance: middle” may be set in a case in which the handwriting is yellow, and “importance: high” may be set in a case in which the handwriting is red. The color of the handwriting can be optionally selected by the user by operating the switch of the digital pen 210, for example. In this case, the information processing device 100 performs processing of generating an image displaying the handwriting in color that is selected by the user at the time of generating the handwriting image by the display data generation unit 171, and projecting the image from the projector 410.

A correspondence between the importance and the text, the shape of the mark, and the color illustrated in FIG. 8 is merely an example, and the present embodiment is not limited thereto. Such a correspondence may be previously set as a default on the system side, or may be customized and registered by the user. The “importance” also includes meanings such as urgency and priority.

In this way, the importance can be automatically set based on the content of the handwriting input performed on the environmental object in the living space. A feeling of the user at the time of inputting the task (a feeling such as “this task is a serious matter” and “important”) is assumed to be reflected in the shape of the mark or the color of the pen. For example, the user is assumed to behave such that the user writes the task in red or encloses the task by a plurality of marks if the user thinks that the task is important. According to the present embodiment, by performing the task registration based on the content of the handwriting input, the user's feeling at the time of input can be grasped, and the user can complete the input more intuitively.

Next, in a case of registering a security level (Yes at Step S175), the information processing device 100 sets the security level based on the content of the user input to the registration UI and the written content (Step S178). As the security level of the task, for example, settings such as public (for example, all housemates can browse the task), private (for example, only a registered user can browse the task), and customized (for example, a registered user and a specified housemate can browse the task) can be exemplified.

Subsequently, in a case of registering a repetition notification (Yes at Step S181), the information processing device 100 sets the repetition notification based on the content of the user input to the registration UI and the written content (Step S184). In the setting of the repetition notification, for example, performed is setting of the number of times or frequency of repetition, specifically, setting of the number of times of repetition of the notification and intervals (in minutes) of repetition until a completion operation of the task is performed, for example. In a case in which the repetition frequency is set to be high, the information processing device 100 may automatically set the notification place so that the notification will be repeatedly made at an entrance through which the person to be notified surely passes at the time of going out. The notification setting for the entrance may be set in a case in which the importance described above is high.

By setting the repetition notification as described above, the notification can be prevented from being missed. Such a repetition notification may be set each time by the user via the registration UI and the like, may be previously set as a default or customized content, or may be automatically set in accordance with the content of the task such as a case in which the importance is high.

The registration processing of the attribute information included in the additional information according to the present embodiment has been specifically described above. The attribute information according to the present embodiment is not limited to the items described above. Another item may be further added, and all of the items described above are not necessarily registered.

The operation processing illustrated in FIG. 7 is merely an example, and the present disclosure is not limited to the example illustrated in FIG. 7. For example, the present disclosure is not limited to an order of the steps illustrated in FIG. 7. At least some of the steps may be performed in parallel, or may be performed in reverse order. For example, pieces of the processing from Step S169 to Step S172, pieces of the processing from Step S175 to Step S178, and pieces of the processing from Step S181 to Step S184 may be performed in parallel, or may be performed in reverse order.

All pieces of the processing illustrated in FIG. 7 are not necessarily performed, and all pieces of the processing are not necessarily performed by a single device. The pieces of processing illustrated in FIG. 7 are not necessarily performed in temporal sequence.

3-2. Notification Processing

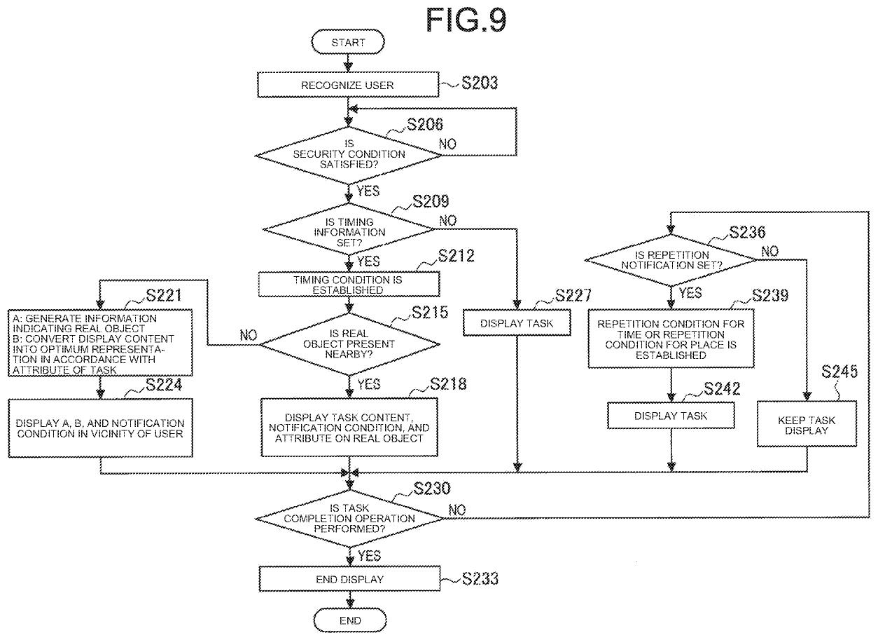

FIG. 9 is a flowchart illustrating an example of a procedure of notification processing according to the present embodiment. The information processing device 100 performs notification control by referring to the additional information of the task stored in the storage unit 190 while continuously recognizing the situation in the space (presence/absence of a person, and the like) based on the sensing data acquired from the sensor device 300.

As illustrated in FIG. 9, first, the information processing device 100 recognizes the user present in the space based on the sensing data acquired from the sensor device 300 (Step S203). The information processing device 100 may recognize only presence/absence of a person in the space, or may further perform personal identification based on a face image, a characteristic of a voice, biosensor data, an ID, and the like.

Next, the information processing device 100 determines whether a security condition (security level) is satisfied (Step S206). For example, the information processing device 100 determines whether the security condition is satisfied depending on whether a plurality of people are present in the space, and who are present. Regarding a task for which the security condition is not set, the processing is skipped.

Subsequently, the information processing device 100 checks whether timing information is set (Step S209). The timing information is the notification time included in the notification condition described above.

Next, in a case in which the timing information is not set (Yes at Step S209), the information processing device 100 displays the registered task content on the real object associated with the task, in the vicinity of the person to be notified, or at a predetermined notification place that is registered (Step S227). In this case, the information processing device 100 may perform control so that the task content is always displayed. In a case in which the person to be notified moves to another room, the information processing device 100 may continuously project the task content on a wall, a floor, a desk, and the like in the periphery following the movement of the person to be notified. The task content to be displayed is, for example, the handwriting image written by hand using the digital pen 210, a finger, and the like that is saved at the time of input.

Subsequently, in a case in which the timing information is set (Yes at Step S209), the information processing device 100 determines whether a timing condition is established (Step S212).

Next, in a case in which the timing condition is established, the information processing device 100 examines whether the real object associated with the task is present in the vicinity of the person to be notified (in the same space as the person to be notified) (Step S215).

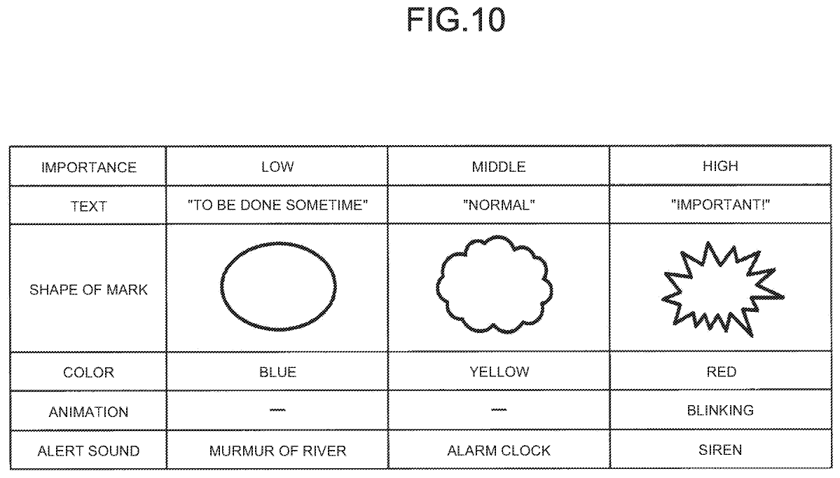

Subsequently, in a case in which the real object is present in the vicinity (Yes at Step S215), the information processing device 100 performs control for displaying the task content, the notification condition, and the attribute on the real object (Step S218). The task content is, for example, the handwriting image written by hand using the digital pen 210, a finger, and the like that is saved at the time of input. The notification condition is, for example, the notification time, the person to be notified, and the notification place. The control for displaying the attribute is, for example, change of the display mode in accordance with the importance. For example, the information processing device 100 may change the display mode such as a shape of the mark enclosing the task content, and a display color, blinking, a background color, and the like of the task content in accordance with the set importance. In a case in which the importance is high, the information processing device 100 may automatically add text indicating a degree of importance (for example, “important!”, “serious!”, and the like) to be displayed. FIG. 10 illustrates an example of output representation of the task importance. As illustrated in FIG. 10, the output representation is assumed to be text, the shape of the mark (that encloses the handwriting image), a color, an animation, an alert sound, and the like corresponding to the importance. In this way, by changing the output representation in accordance with the attribute of the task even in the same modal, the notification can be made with optimum representation corresponding to the importance of the task.

Even in a case in which the real object related to finish of the task is not present nearby at the time of task registration, and the real object is unavoidably designated by text or voice to be input to a surrounding environmental object (a wall, a door, a floor, a table, or the like), if the real object information is registered as related information and the real object is present in the vicinity of the person to be notified at the notification timing, the task content can be displayed on the real object to be notified. For example, in a case in which the user thinks of taking out garbage at 9:00 in a kitchen where a trash can is not present, the user writes “trash can, 9:00, important!” on a wall of the kitchen using the digital pen 210. Subsequently, in a case in which there is a trash can in the vicinity of the user at the time when the timing condition is established at 9:00, the information processing device 100 displays (projects) the task content on the trash can. At this point, the task content is set as “importance: high” by writing “important!” at the time of registration, so that the information processing device 100 may enclose the handwriting image of “9:00” with a specific jagged mark (refer to FIG. 10) to be displayed.

At Step S218 illustrated in FIG. 9, described is “displaying the task content, the notification condition, and the attribute on the real object”, but the present embodiment is not limited thereto. For example, the information processing device 100 may display (project) only the task content on the real object, or display only the task content converted into optimum representation corresponding to the attribute.

On the other hand, in a case in which the real object is not present in the vicinity of the person to be notified (No at Step S215), the information processing device 100 generates information indicating the real object (A), and performs processing of converting the display content into optimum representation in accordance with the attribute of the task (B) (Step S221). The information indicating the real object is text (a name of the real object), a taken image (a taken image obtained by imaging the real object), an illustration (an illustration image of the real object, which may be acquired from a cloud based on the name of the real object, or may be automatically generated), and the like. Conversion of the task content into the optimum representation in accordance with the attribute of the task is the same as the content described above at Step S218. Such conversion of representation may be performed not only on the task content but also on the generated “information indicating the real object”. For example, in a case in which the importance of “high” is designated by enclosing the real object with a jagged mark at the time of task registration, the information processing device 100 may convert the image of the real object into a blinking animation, or in a case of generating text representing the name of the real object, the information processing device 100 may change the color of the text into red. Variations of the output representation corresponding to the importance are illustrated in FIG. 10.

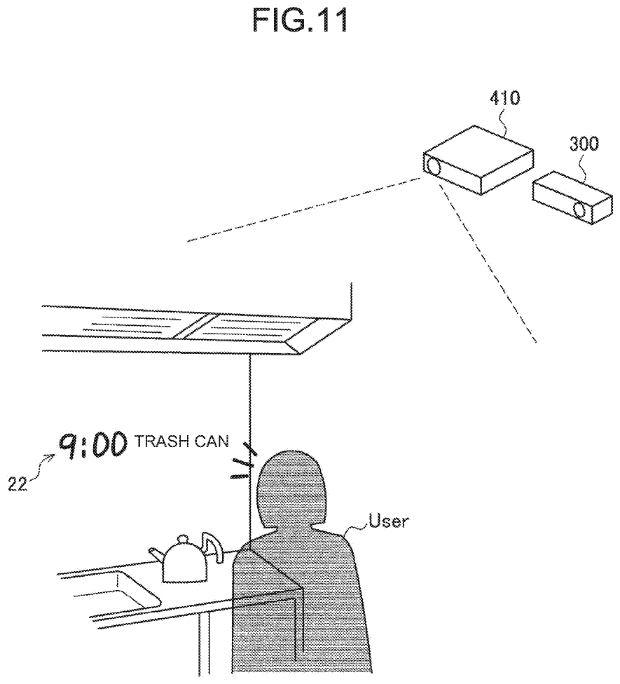

Subsequently, the information processing device 100 performs control for displaying the information indicating the real object, the task content converted into optimum representation corresponding to the attribute, and the notification condition in the vicinity of the person to be notified (Step S224). However, the notification condition is not necessarily displayed. FIG. 11 illustrates an example of task display in a case in which the real object is not present nearby according to the present embodiment. As illustrated in FIG. 11, in a case in which a predetermined real object is not present in the vicinity of the user when the notification condition is satisfied, the information processing device 100 displays notification information 22 including the information indicating the real object and the task content in the periphery of the user or in the sight line direction of the user. In the example illustrated in FIG. 11, the registered real object “trash can” is not present, so that the information processing device 100 displays the task content “9:00” together with the text of “trash can”. The information processing device 100 may cause the notification information 22 to move to attract attention of the user.

In this way, the representation can be converted into different modals such as a voice and a sense of touch to be notified in a case in which the real object is not present in the vicinity of the person to be notified at the time of task notification, but these modals are not necessarily appropriate depending on the notification time, the situation of the user, and the task content. Accordingly, in the present embodiment, by generating the information indicating the real object to be displayed together with the task content, the notification processing can be performed more flexibly.

In the present embodiment, the handwriting image input by hand is exemplified as an example of the task content to be displayed, but the present embodiment is not limited thereto. For example, in a case in which the task is registered by inputting text using a smartphone, a tablet terminal, and the like, the information processing device 100 may convert the text into handwriting-like characters including a characteristic of handwriting specific to the user who has input the text, and may display the handwriting-like characters as the task content. Due to this, individuality not included in dry text can be imparted to the task content. Additionally, in a case in which a user A performs input to display the task for a user B, for example, an individual can be specified due to the characteristic of handwriting without clearly writing the fact that the user A has requested to finish the task, which contributes to simplification of the registration.

When a completion operation of finishing the task is performed (Yes at Step S230), the information processing device 100 ends display of the notification information (the task content, the notification condition, display of the real object, the attribute, and the like) (Step S233). The completion operation of finishing the task may be performed at the timing when the user starts to finish the task or completely finishes the task. For example, the user may push a task completion button on the GUI with a touch pen or a fingertip, or may touch the task completion button that is displayed (projected) together with the notification information with a fingertip. A completely finishing operation may be performed by drawing a predetermined mark such as an oblique line or a cross in a display region of the notification information by the user with the digital pen 210, a finger, and the like, or by a gesture of whisking the display region of the notification information by hand. The completely finishing operation may also be performed by inputting a specific command such as “finish the task” by voice. When the completion operation of finishing the task is performed, the information processing device 100 ends the notification of the notification information, and may delete the information of the task from the storage unit 190, or may set a completion flag to the task in the notification list at the same time.

On the other hand, in a case in which the completion operation of finishing the task is not performed (No at Step S230), the information processing device 100 determines whether the repetition notification is set (Step S236).

Subsequently, in a case in which the repetition notification is set (Yes at Step S236), at the time when a set repetition condition is established (Step S239), the information processing device 100 displays the task (specifically, the task content, the notification condition, the information indicating the real object, and the attribute information) again (Step S242). The repetition notification is repeatedly performed at the same place (on the real object in a case in which the real object is present) at a set frequency. In a case in which the person to be notified moves to another room or an entrance while the completion operation of finishing the task is not performed, the information processing device 100 may make the repetition notification in the vicinity of the person to be notified.

On the other hand, in a case in which the repetition setting is not performed (No at Step S236), the information processing device 100 keeps the task display as it is until the completion operation of finishing the task is performed (Step S245).

The notification processing according to the present embodiment has been specifically described above with reference to FIG. 9. The operation processing illustrated in FIG. 9 is merely an example, and the present disclosure is not limited to the example illustrated in FIG. 9. For example, the present disclosure is not limited to an order of the steps illustrated in FIG. 9. At least some of the steps may be performed in parallel, or may be performed in reverse order. For example, the processing at Step S203, the processing at Step S206, and the processing at Step S209 may be performed in parallel, or may be performed in reverse order.

All pieces of the processing illustrated in FIG. 9 are not necessarily performed. For example, in a case in which the person to be notified is not specified, the information processing device 100 may detect only presence/absence of a person from a human sensor or a camera without performing personal identification of a person at Step S203. In this case, for example, if presence of a person is checked in the space at the time when the timing condition is established, the information processing device 100 may display the real object related to finish of the task present in the same space, or display the notification information in the vicinity of that person. In a case in which the person to be notified is not specified, the information processing device 100 may display the notification information on the real object related to finish of the task or a predetermined notification place irrespective of presence/absence of a person.

In a case in which the real object is not associated with the task and the timing condition is established, the information processing device 100 may display the notification information in the vicinity of the person to be notified (in the sight line direction in a case in which the sight line direction is determined by detecting orientation and the like of a head of the person to be notified) or at a registered notification place.

All pieces of the processing illustrated in FIG. 9 are not necessarily performed by a single device, and the respective pieces of processing are not necessarily performed in temporal sequence.

### 4. COMPLEMENT

Subsequently, the following complements the present embodiment.

4-1. Pool Display

The embodiment describe above mainly describes a case of notifying the user of the registered task at the set timing, but the present embodiment is not limited thereto. The registered task may be always displayed at a predetermined place (hereinafter, also referred to as a pool place) such as a wall of a room. Due to this, the user can grasp an amount of tasks currently held by himself/herself more intuitively. Image data of the task to be displayed may be only the handwriting image corresponding to the task content, or the notification condition or the attribute of the task may be added thereto.

The information processing device 100 performs control for always displaying the task at a predetermined pool place even in a case in which the notification place of the task is registered as “kitchen”, for example, and displaying the task in “kitchen” to be notified at the time when the timing condition is established.

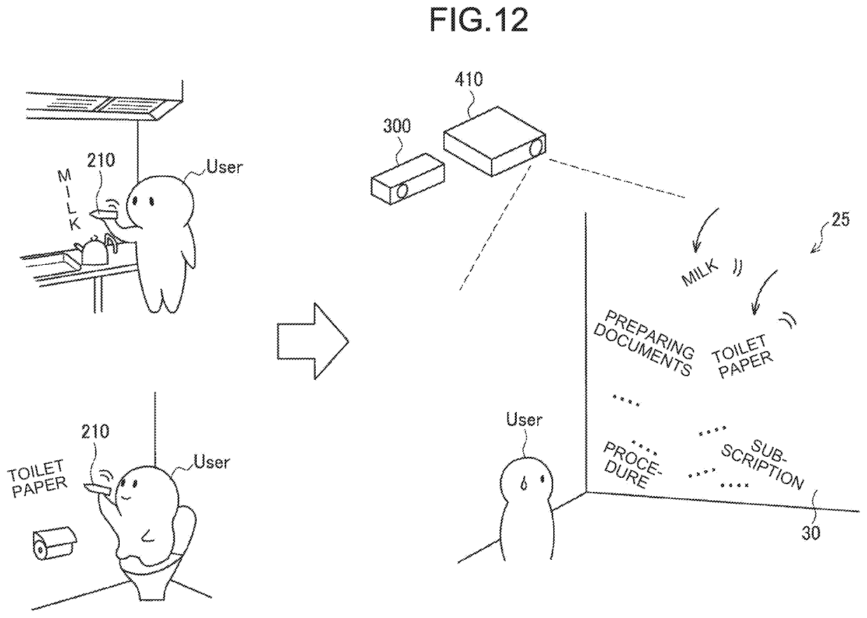

The following describes an example of pool display according to the present embodiment with reference to FIG. 12. As illustrated on the left side of FIG. 12, for example, in a case of thinking of a task at a kitchen or a toilet, the user writes the task on a wall to be registered with the digital pen 210, a finger, or the like. The information processing device 100 then collectively displays registered tasks at a predetermined pool place 30 (for example, a wall of a room) as illustrated on the right side of FIG. 12. Due to this, the user can grasp the amount of tasks currently held by himself/herself at a glance.

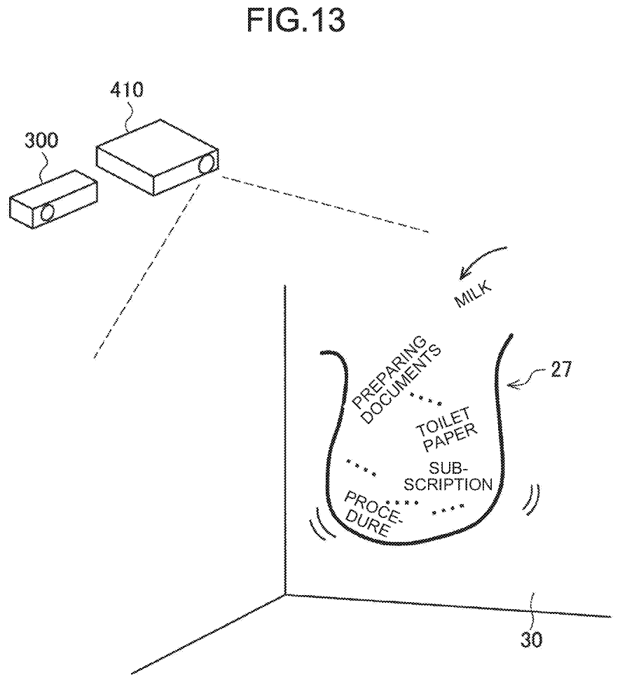

Pool representation according to the present embodiment is not limited to the example illustrated in FIG. 12. For example, as illustrated in FIG. 13, bag-like display 27 may be used. The information processing device 100 can represent weightiness of the task more intuitively by controlling a degree of stretching or a spread of the bag-like display 27 in accordance with the number of tasks to be displayed, for example.

To the image data of each task displayed at the pool place 30, parameters such as mass, elasticity, attraction, a size, a color, or the like may be given. The information processing device 100 controls a display position, a display arrangement, a display size, a display color, a motion (animation), or the like in accordance with the parameters at the time of displaying the image data of the task at the pool place 30, and enables the state of the pooled tasks to be presented to the user more intuitively.

“Mass” is a parameter based on cost (time, a staff, a tool, and the like) required for finishing the task, for example, and used by the information processing device 100 to represent the weightiness of the task at the time of being pool-displayed. Specifically, a task having large mass (for example, a heavy task that takes much time to be finished) is displayed at a lower part at the time of being pool-displayed, and a task having small mass (for example, a light task that takes little time to be finished) is displayed at an upper part at the time of being pool-displayed. At the time of adding a task that is newly registered to the pool display, the information processing device 100 may add an animation such that the task sinks to the bottom or an animation such that the task floats up in accordance with the mass.

The mass parameter may be input by the user as a kind of attribute via the registration UI and the like at the time of registration. For example, the mass parameter is assumed to be very heavy: 2 hours or more, heavy: 1 to 2 hours, normal: 30 minutes to 1 hour, light: 5 minutes to 30 minutes, very light: 5 minutes or less, and the like. The system side may automatically give a mass parameter set in advance in accordance with the task content. By measuring time actually taken for finishing the task to learn a tendency, and the information processing device 100 may automatically give an appropriate mass parameter. To measure the time taken for finishing the task, for example, a timer screen is displayed at the time of task notification, and the user taps a start button on the timer screen at the time of starting to finish the task and taps a stop button at the time of ending. Accordingly, the information processing device 100 can record the time actually taken for finishing the task.

For example, “elasticity” is a parameter based on the state of the task such as freshness, enjoyment, or stiffness of the task (whether the task is official or private, for example), and used by the information processing device 100 to represent softness of the task at the time of being pool-displayed. Specifically, the information processing device 100 may give a soft color, design, or decoration to the image data of the task having a high elasticity parameter (for example, a task that has been registered recently, or an enjoyable task) to be displayed, or may add a bouncing animation thereto. The elasticity parameter may be input as a kind of attribute via the registration UI and the like by the user at the time of registration, or the system side may automatically give a parameter set in advance in accordance with the task content.

“Attraction” is a parameter indicating a degree of relevance to the other tasks. The relevance is a similarity or a matching degree between pieces of the task content or between notification conditions. For example, at the time of performing pool display, the information processing device 100 may display tasks both having high attraction parameters to be close to each other, or to seem to be attracted to each other by magnetic force. The information processing device 100 may also display tasks both having low attraction parameters to be away from each other, or to seem to repel each other by magnetic force. The attraction parameter may be input as a kind of attribute via the registration UI and the like by the user at the time of registration (which task has high relevance, for example), or may be automatically set by the system side in accordance with the task content or the notification condition.

“Size” is, for example, a parameter that is set based on a deadline for finishing the task (a date and time registered as a deadline, notification time, or the like), cost required for finishing the task, and the like. For example, the information processing device 100 can represent a sense of oppression by displaying the image data of the task the deadline (or the notification time) of which nears to be large in inverse proportion to the number of days left, and can urge the user to finish the task. The date and time as a deadline of the task may be enabled to be input by the user via the registration UI separately from the notification condition.

“Color” is, for example, a parameter based on a finished/unfinished state of the task, the importance (included in the attribute information described above), a finishing place (notification place), or a user having charge of finishing the task (person to be notified), and used by the information processing device 100 for determining the display color of the task at the time of being pool-displayed. By displaying the tasks in different colors for respective finishing places and users having charge of finishing the task, the user can intuitively grasp the amount of tasks to be finished at a certain place, or the amount of tasks to be finished by a certain person at a glance. By displaying the image data of the task having high importance in a conspicuous color such as red, the user can pay attention to the important task. By changing the color of a finished task to a color having low brightness and leaving display thereof at the pool place not to disappear, the user can look back finish of the task in the past, and can get a sense of achievement. The information processing device 100 may cause a finished task to become gradually pale (transmitted) with the lapse of time, and to disappear in the end.

The parameters described above are merely examples. Another parameter may be further added, or the attribute information and the information such as the notification condition, the task content, and the registrant described above may be used for calculating the parameter.

The information processing device 100 may assume that the size of the pool place (or display of a bag, a box, and the like displayed at the pool place) is a size of capacity for finishing the task of the user, and may perform display control so that the tasks overflow the pool place in a case in which the capacity for finishing the task of the user is exceeded. The case in which the capacity for finishing the task of the user is exceeded may be determined, for example, based on the time required for finishing each task, the number of days left until the deadline, the number of tasks, or the like, may be determined based on a track record of finish of tasks of the user, or may be determined by taking a schedule of the user into consideration. Due to this, the user can grasp that he/she has excessive tasks, and can easily and visually make a plan to finish the task such as finishing a smaller task (a task displayed to be small because the cost required for finishing the task is small) before the date and time as a deadline or the notification time comes.

Grouping

The information processing device 100 may group the tasks having the same or similar people to be notified, notification places, notification conditions, or the like to be pool-displayed. Grouping may be represented by using different colors, by enclosing the tasks by an enveloping line or a figure to be recognized as a cluster, or by using animations of the same motion.

Due to this, for example, by displaying tasks held by a husband and tasks held by a wife separately on a wall and the like, types of the tasks and the amount thereof currently held by each person can be mutually and intuitively grasped. Thus, for example, at the time of determining partial charge of housework, it is possible to advantageously determine which person finishes the task while grasping each other's situation. By reflecting the display size or the weightiness in the display mode using the parameters described above, for example, communication may be generated such that the husband moves the task from the pool display for the wife to his pool display, and takes charge of the task while considering the weight and the like of the task. At the time when the task is moved from the pool place for the wife to the pool place for the husband, the information processing device 100 changes the person to be notified (person who finishes the task) included in the notification condition for the task from “wife” to “husband”.

By adding a display region for a common task, in a case in which the tasks of each person are maximum, a task can be moved to the common task, and it is possible to visually plan to finish the task cooperating with each other. The user can also drag the task written on a wall and the like to a pool display region for a person taking charge of finishing the task by gesture and the like, and designate the person who finishes the task (a person taking charge of notification) by intuitive operation.

Automatic Assignment

At the time when the tasks for respective people to be notified (people who finish the task) are displayed in a separated manner, in a case in which a common task that may be finished by any user (for example, housework such as taking out garbage, cleaning, and shopping) is registered, the information processing device 100 may perform display control for automatically assigning the common task to a user having a smaller number of pooled tasks, and adding the task to the pool place for that user.

The information processing device 100 may also group the tasks for each person to be notified and common tasks to be displayed in the pool place, and may automatically assign the common task to any one of users in a case in which the common task is increased.

In a case of adding the task to any one of the users by automatic assignment, the information processing device 100 may notify an object person that the task is automatically assigned. By informing the object person that the automatic assignment is performed by the system as a third party, it can be expected that the user understands that assignment is properly made based on objective determination, and willingly accepts the task.

The variations of pool display described above can be optionally combined with each other.

4-2. Application Example

Next, the following describes an application example of the system according to the present embodiment.

4-2-1. Measure for Never Forgetting Real Object that should be Carried when Going Out

For example, assumed is a case in which a user A thinks of, at night before the day of going to his/her office, a task of putting a letter in a post on the way to the nearest station tomorrow morning. The user A puts the letter on a desk in his/her room because a deadline for arrival of the letter is just ahead, touches the letter with the digital pen 210 (a designating operation of a related real object), encloses the periphery of the letter by a jagged mark (representation indicating an important task) thereafter, writes “post it tomorrow morning!”, and registers the task.

In the morning of the following day, when the user A gets up and passes in front of the desk, the mark and words that were written yesterday are projected by the projector 410. The user A remembers the task by viewing the projected notification information, but goes to a toilet without carrying the letter because he/she wants to go to the toilet immediately. Thereafter, a task completion operation is not performed, so that the information processing device 100 repeatedly notifies the user of the task content in accordance with the repetition setting. Specifically, the information processing device 100 continuously displays the task on a wall or a table in the periphery following the user A preparing for departure, but the user A does not notice the task in some cases because he/she is too busy. At the time when the user finally moves to an entrance, the information processing device 100 displays, with blinking, an image of the letter (display indicating the real object) and the words of “post it tomorrow morning!” (handwriting image) on a door of the entrance, and enables the user A to notice that he/she left the letter in the room by final notification.

4-2-2. Use as Replacement for Whiteboard in Office Scenes

By applying the system according to the present embodiment to office scenes, a memo or a task can be drawn and registered on a wall or a desk in a conference room, a wall of a corridor, a personal desk, and the like at any time with the digital pen 210, a finger, and the like.

For example, the user can do brainstorming with a staff who encounters the user in a corridor of a company while freely drawing characters or illustrations on a wall with the digital pen 210 or a fingertip, and can register an important idea that occurs to the user as a task. In this case, the user can enclose a material or a prototype held by himself/herself at the time of brainstorming by using the digital pen 210 or give a specific mark thereto to be imaged by the camera 350 disposed in the periphery, and can cause a taken image to be output on a wall. Due to this, information is enabled to be disclosed and shared without limitation of virtuality and the real.

The registered idea is saved on the system side, so that the idea can be displayed on the desk at the time when the user returns to his/her seat thereafter, or can be displayed on a PC, a tablet terminal, and the like as image data or text data.

By continuously displaying the idea having occurred to the user together with words of “if you have another idea, please write it here!” on the wall of the corridor, other passing staffs can participate in writing ideas afterward to brush up the idea, for example. The information processing device 100 may perform control for displaying and outputting a handwriting image of such an idea drawn on the wall at the time when a staff passes in front of the wall.

4-2-3. Transmit Task Having Occurred to User when Going Out to Home

With the system according to the present embodiment, a task that is registered away from home can be displayed in home. For example, a user goes out after putting on makeup with foundation that is newly purchased, but the user feels a sense of incongruity on his/her skin, and recognizes that the foundation does not agree with his/her skin. The user then starts an application of a smartphone, sets “foundation” as a real object to be displayed as a task, and inputs “Don't use. Examine new foundation” as task content to be registered. In a case in which the user returns home and enters a bedroom that day, the information processing device 100 highlights the periphery of the foundation put on a dressing table in the bedroom with a specific mark, and displays (projects) words of “Don't use. Examine new foundation” based on the registered task. In this way, the task that is registered away from home using a smartphone and the like can be displayed on the related real object in home, and convenience of task management by the user can be greatly improved.

4-3. Effects

The system according to the present embodiment has been specifically described above.

According to the present embodiment, the task content is output (specifically, displayed and projected) at a place where the task should be finished or on the real object used for finishing the task, so that the user can intuitively grasp the task and immediately get down to work, and efficiency is improved accordingly.

At the time of notifying the task satisfying the notification condition, the information processing device 100 may also output another task that can be finished at the same place (including a task not satisfying the notification condition) at the same time. Due to this, the user can finish the other task on the occasion, and efficiency can be further improved.

Even in a case in which the real object is not present in the vicinity of the user (person to be notified), by displaying the information indicating the real object around the user together with the notification content, the user is enabled to more intuitively grasp what the task is for.

The task content to be displayed is a handwriting image input by hand, so that various kinds of task content such as a character, a chart, and an illustration can be handled, and convenience of task management is improved.

In the embodiment described above, “task” is used as an example of the notification information, but the present embodiment is not limited thereto. The notification information may be “idea”, “message”, “memo”, and the like. It is possible to implement communication between family members such as leaving a message together with an illustration and the like and outputting them to a family member the living time zone of whom is different.

### 5. HARDWARE CONFIGURATION

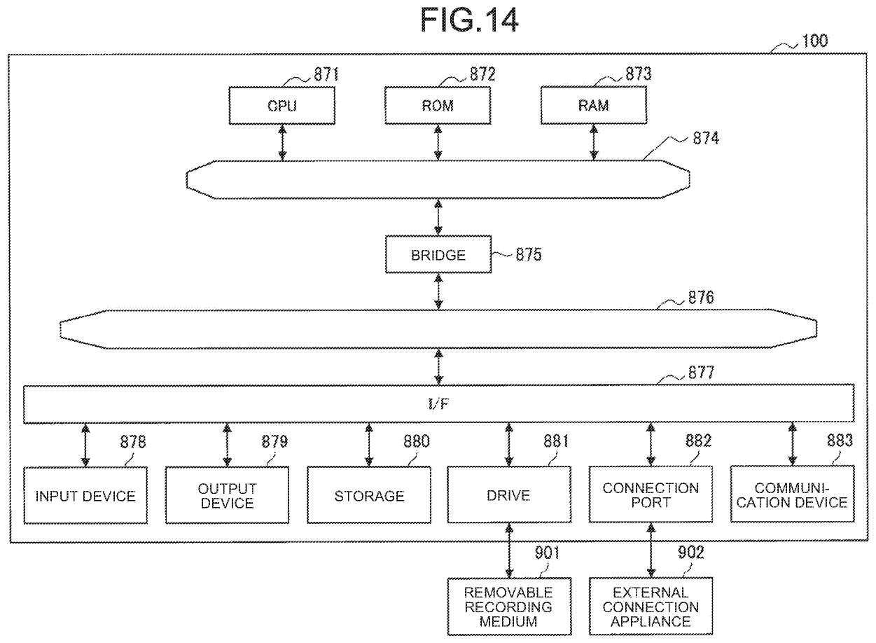

Next, the following describes a hardware configuration example of the information processing device 100 according to one embodiment of the present disclosure. FIG. 14 is a block diagram illustrating a hardware configuration example of the information processing device 100 according to one embodiment of the present disclosure. In FIG. 14, the information processing device 100 includes, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. The hardware configuration described herein is merely an example, and part of constituent elements thereof may be omitted. The hardware configuration may further include a constituent element other than the constituent elements described herein.

CPU 871

The CPU 871 functions, for example, as an arithmetic processing device or a control device, and controls the entire or part of operations of the constituent elements based on various computer programs recorded in the ROM 872, the RAM 873, the storage 880, or a removable recording medium 901.

Specifically, the CPU 871 implements the operations of the handwriting recognition unit 120, the gesture detection unit 130, the map management unit 140, the user position specification unit 150, the user recognition unit, and the control unit 170 in the information processing device 100.

ROM 872, RAM 873

The ROM 872 is a unit that stores a computer program read by the CPU 871, data used for an arithmetic operation, and the like. For example, the RAM 873 temporarily or permanently stores a computer program read by the CPU 871, various parameters that vary as appropriate at the time when the computer program is executed, and the like.

Host Bus 874, Bridge 875, External Bus 876, Interface 877

The CPU 871, the ROM 872, and the RAM 873 are connected to each other via the host bus 874 that can perform fast data transmission, for example. On the other hand, the host bus 874 is connected, via the bridge 875, to the external bus 876 the data transmission speed of which is relatively low, for example. The external bus 876 is connected to various constituent elements via the interface 877.

Input Device 878

As the input device 878, for example, a mouse, a keyboard, a touch panel, a button, a switch, and a lever are used. Additionally, as the input device 878, a remote controller (hereinafter, referred to as a remote control) may be used, the remote control being able to transmit a control signal by utilizing infrared rays or other radio waves. The input device 878 may also include a voice input device such as a microphone.

Output Device 879

The output device 879 is, for example, a device that can visually or aurally notifies the user of acquired information, that is, a display device such as a Cathode Ray Tube (CRT), an LCD, or an organic EL, an audio output device such as a speaker and a headphone, a printer, a cellular telephone, a facsimile, or the like. The output device 879 according to the present disclosure includes various vibration devices that can output tactile stimulation.

Storage 880

The storage 880 is a device for storing various kinds of data. As the storage 880, for example, used are magnetic storage device such as a hard disk drive (HDD), a semiconductor storage device, an optical storage device, a magneto-optical storage device, or the like.

Drive 881

The drive 881 is, for example, a device that reads out information recorded in the removable recording medium 901 such as a magnetic disc, an optical disc, a magneto-optical disc, or a semiconductor memory, or writes information into the removable recording medium 901.

Removable Recording Medium 901

The removable recording medium 901 is, for example, a DVD medium, a Blu-ray (registered trademark) medium, an HD DVD medium, various kinds of semiconductor storage media, or the like. Obviously, for example, the removable recording medium 901 may be an IC card on which a contactless IC chip is mounted, an electronic appliance, or the like.

Connection Port 882

The connection port 882 is, for example, a port for connecting an external connection appliance 902 such as a Universal Serial Bus (USB) port, an IEEE1394 port, a Small Computer System Interface (SCSI), an RS-232C port, or an optical audio terminal.

External Connection Appliance 902

The external connection appliance 902 is, for example, a printer, a portable music player, a digital camera, a digital video camera, an IC recorder, or the like.

Communication Device 883

The communication device 883 is a communication device for making a connection to a network, and examples thereof include a communication card for a wired or wireless LAN, Wi-Fi (registered trademark), Bluetooth (registered trademark), or Wireless USB (WUSB), a router for optical communication, a router for Asymmetric Digital Subscriber Line (ADSL), a modem for various kinds of communication, or the like.

### 5. CONCLUSION

The preferred embodiment of the present disclosure has been described above in detail with reference to the attached drawings, but the present technique is not limited thereto. A person ordinarily skilled in the art of the present disclosure may obviously conceive various examples of variations or modifications without departing from the technical idea disclosed in CLAIMS, and these variations or modifications are obviously encompassed by the technical scope of the present disclosure.

For example, it is possible to create a computer program for causing hardware such as a CPU, a ROM, and a RAM incorporated in the information processing device 100 described above to function as the information processing device 100. Additionally, a computer-readable storage medium storing the computer program is provided.

The effects described in the present description are provided as merely explanations or examples, and are not provided as limitation. That is, the technique according to the present disclosure can exhibit other effects that are obviously conceivable by those skilled in the art based on the description herein in addition to the effects described above, or in place of the effects described above.

The present technique can also employ the following configuration.

(1)

An information processing device comprising:

a control unit configured to perform
processing of determining whether a real object associated with notification content is present in a same space as a person to be notified at the time when a notification condition associated with the notification content is satisfied, and
processing of outputting the notification content to a position related to the real object depending on whether the real object is present.
   (2)

The information processing device according to (1), wherein

the control unit
outputs the notification content to the position related to the real object in a case in which the real object is present, and
outputs the notification content to the same space as the person to be notified together with information indicating the real object in a case in which the real object is not present.
   (3)

The information processing device according to (2), wherein the position related to the real object is at least one of positions on the real object or in periphery of the real object.

(4)

The information processing device according to (2), wherein the notification condition includes at least notification time, a notification place, or the person to be notified.

(5)

The information processing device according to (4), wherein the notification time is predetermined time, a timer setting, or a predetermined timing.

(6)

The information processing device according to (4) or (5), wherein the control unit performs control for displaying the notification content on the real object at the notification place in a case in which a condition for the notification time is satisfied.

(7)

The information processing device according to any one of (4) to (6), wherein

the control unit
recognizes the person to be notified based on sensing data acquired from a space, and,
at the notification time, outputs the notification content on the real object in a case in which the real object is present, and outputs the notification content in vicinity of the person to be notified together with the information indicating the real object in a case in which the real object is not present.
   (8)

The information processing device according to any one of (4) to (7), wherein

attribute information is associated with the notification content, and

the control unit controls output of the notification content in accordance with the attribute information.

(9)

The information processing device according to (8), wherein

the attribute information includes importance, and

the control unit changes an output mode at the time of outputting the notification content in accordance with the importance.

(10)

The information processing device according to (8) or (9), wherein

the attribute information includes a security condition, and

the control unit performs control for outputting the notification content in a case in which the notification condition and the security condition are satisfied.

(11)

The information processing device according to any one of (8) to (10), wherein

the attribute information includes a repetition setting, and

the control unit performs processing of repeatedly outputting the notification content in accordance with the repetition setting.

(12)

The information processing device according to any one of (4) to (11), wherein the control unit detects a first input operation of inputting the notification content performed by an input person based on sensing data acquired by an environment sensor disposed in a space.

(13)

The information processing device according to (12), wherein

the first input operation is an input operation using an operation body, and

the control unit performs control for
detecting a locus of the operation body based on the sensing data, and
projecting the detected locus.
   (14)

The information processing device according to (13), wherein

the control unit performs processing of:
detecting a second input operation of registering the notification content performed by the input person based on the sensing data; and
storing the projected locus in a storage unit as notification information at the time when the second input operation is detected.
   (15)

The information processing device according to (14), wherein

the control unit
recognizes the real object related to the notification content based on the first input operation, and
stores information indicating the recognized real object in the storage unit in association with the notification content.
   (16)

The information processing device according to (14), wherein the control unit performs control for displaying the notification information stored in the storage unit in a predetermined region in a space irrespective of whether the notification condition is satisfied.

(17)

The information processing device according to (16), wherein the control unit controls a display mode of the notification information in the predetermined region based on a parameter added to the notification information.

(18)

The information processing device according to (16) or (17), wherein the control unit groups the notification information in accordance with the notification time, the person to be notified, or the notification place to be displayed in the predetermined region.

(19)

An information processing method comprising:

determining, by a processor, whether a real object associated with notification content is present in a same space as a person to be notified at the time when a notification condition associated with the notification content is satisfied; and

outputting, by the processor, the notification content to a position related to the real object depending on whether the real object is present.

(20)

A recording medium in which a computer program is recorded, the computer program for causing a computer to function as a control unit configured to perform:

processing of determining whether a real object associated with notification content is present in a same space as a person to be notified at the time when a notification condition associated with the notification content is satisfied; and

processing of outputting the notification content to a position related to the real object depending on whether the real object is present.

### REFERENCE SIGNS LIST

1 System
10 Real object
20 Notification information
21 Handwriting image
22 Notification information
100 Information processing device
110 I/F unit
120 Handwriting recognition unit
130 Gesture detection unit
131 Voice recognition unit
140 Map management unit
150 User position specification unit
160 User recognition unit
170 Control unit
171 Display data generation unit
173 Task registration unit
180 Timer
190 Storage unit
200 Input device
210 Digital pen
220 Touch panel
230 Keyboard
300 Sensor device
310 Human sensor
320 Acceleration sensor
330 Depth sensor
340 Microphone
350 Camera
360 Gyro sensor
370 Geomagnetic sensor
400 Output device
410 Projector
420 Display
430 Speaker
440 Unidirectional speaker
874 Host bus
875 Bridge
876 External bus
877 Interface
878 Input device
879 Output device
880 Storage
881 Drive
882 Connection port
883 Communication device
901 Removable recording medium
902 External connection appliance

1. An information processing device comprising:
a control unit configured to perform
processing of determining whether a real object associated with notification content is present in a same space as a person to be notified at the time when a notification condition associated with the notification content is satisfied, and
processing of outputting the notification content to a position related to the real object depending on whether the real object is present.

2. The information processing device according to claim 1, wherein
the control unit
outputs the notification content to the position related to the real object in a case in which the real object is present, and
outputs the notification content to the same space as the person to be notified together with information indicating the real object in a case in which the real object is not present.

3. The information processing device according to claim 2, wherein the position related to the real object is at least one of positions on the real object or in periphery of the real object.

4. The information processing device according to claim 2, wherein the notification condition includes at least notification time, a notification place, or the person to be notified.

5. The information processing device according to claim 4, wherein the notification time is predetermined time, a timer setting, or a predetermined timing.

6. The information processing device according to claim 4, wherein the control unit performs control for displaying the notification content on the real object at the notification place in a case in which a condition for the notification time is satisfied.

7. The information processing device according to claim 4, wherein
the control unit
recognizes the person to be notified based on sensing data acquired from a space, and,
at the notification time, outputs the notification content on the real object in a case in which the real object is present, and outputs the notification content in vicinity of the person to be notified together with the information indicating the real object in a case in which the real object is not present.

8. The information processing device according to claim 4, wherein
attribute information is associated with the notification content, and
the control unit controls output of the notification content in accordance with the attribute information.

9. The information processing device according to claim 8, wherein
the attribute information includes importance, and
the control unit changes an output mode at the time of outputting the notification content in accordance with the importance.

10. The information processing device according to claim 8, wherein
the attribute information includes a security condition, and
the control unit performs control for outputting the notification content in a case in which the notification condition and the security condition are satisfied.

11. The information processing device according to claim 8, wherein
the attribute information includes a repetition setting, and
the control unit performs processing of repeatedly outputting the notification content in accordance with the repetition setting.

12. The information processing device according to claim 4, wherein the control unit detects a first input operation of inputting the notification content performed by an input person based on sensing data acquired by an environment sensor disposed in a space.

13. The information processing device according to claim 12, wherein
the first input operation is an input operation using an operation body, and
the control unit performs control for
detecting a locus of the operation body based on the sensing data, and
projecting the detected locus.

14. The information processing device according to claim 13, wherein
the control unit performs processing of:
detecting a second input operation of registering the notification content performed by the input person based on the sensing data; and
storing the projected locus in a storage unit as notification information at the time when the second input operation is detected.

15. The information processing device according to claim 14, wherein
the control unit
recognizes the real object related to the notification content based on the first input operation, and
stores information indicating the recognized real object in the storage unit in association with the notification content.

16. The information processing device according to claim 14, wherein the control unit performs control for displaying the notification information stored in the storage unit in a predetermined region in a space irrespective of whether the notification condition is satisfied.

17. The information processing device according to claim 16, wherein the control unit controls a display mode of the notification information in the predetermined region based on a parameter added to the notification information.

18. The information processing device according to claim 16, wherein the control unit groups the notification information in accordance with the notification time, the person to be notified, or the notification place to be displayed in the predetermined region.

19. An information processing method comprising:
determining, by a processor, whether a real object associated with notification content is present in a same space as a person to be notified at the time when a notification condition associated with the notification content is satisfied; and
outputting, by the processor, the notification content to a position related to the real object depending on whether the real object is present.

20. A recording medium in which a computer program is recorded, the computer program for causing a computer to function as a control unit configured to perform:
processing of determining whether a real object associated with notification content is present in a same space as a person to be notified at the time when a notification condition associated with the notification content is satisfied; and
processing of outputting the notification content to a position related to the real object depending on whether the real object is present.
